(19) United States
(12) Patent Application Publication
(10) Pub. No.: US 2024/0264037 A1
(43) Pub. Date: Aug. 8, 2024

(54) SYSTEM AND METHOD OF OBSERVING AN OPTICAL DEVICE

(71) Applicant: Politecnico di Milano, Milano (IT)

(72) Inventors: Francesco MORICHETTI, Milano (IT); Andrea Ivano MELLONI, Milano (IT); Matteo PETRINI, Milano (IT); Maziyar MILANIZADEH, Milano (IT)

(73) Assignee: Politecnico di Milano, Milano (IT)

(21) Appl. No.: 18/566,440

(22) PCT Filed: May 30, 2022
(86) PCT No.: PCT/IB2022/055051

§ 371 Date: Dec. 1, 2023

(30) Foreign Application Priority Data
Jun. 8, 2021 (IT) 102021000014828

(51) Int. Cl. G01M 11/02

(52) U.S. Cl. CPC G01M 11/0207

(57) ABSTRACT

An optical system may include an optical radiation source, an optical device, an optical reference device, an optical detector, and a processing module. The optical radiation source may provide an optical input signal. The optical device may provide one or more of a first band-pass output associated a first band-pass wavelength response and a first band-stop output associated with a first band-stop wavelength response. The optical reference device may provide one or more of a second band-pass output associated with a second band-pass wavelength response and a second band-stop output associated with a second band-stop wavelength response. The optical devices may be coupled together and may provide an optical output signal. The optical detector may convert the optical output signal into an electrical measurement signal. The processing module may evaluate deviations between the band-pass responses and the band-stop responses.

### TECHNICAL FIELD

The present invention relates to a method of observing optical devices made, by way of example and not limitation, in integrated optical technology.

### State of the Art

The term “observation” of an optical device means in the present description the tuning, monitoring, testing or controlling of the device under consideration.

In relation to tuning and testing of frequency-selective optical devices, solutions of known art are based on the measurement of the spectral response of the device which is compared with a reference spectral mask.

An example of testing an optical device, of a reconfigurable type, is described in document U.S. Pat. No. 6,892,021. That document describes an optical gain equalizing filter having a waveguide multiplexer (Waveguide Grating Router) equipped with Mach-Zehnder type adjustable optical attenuators, each associated with a relative wavelength of the optical channels employed.

Document U.S. Pat. No. 6,512,414 describes a control system that detects and adjusts the characteristic frequency of a filter that is tuned using a pulse signal or a stepped signal and then stores the tuning result on a memory for future reuse.

Document US-A-2009121802 describes a microwave filter system based on measuring the spectral response of the device to a step signal.

Document WO2015/197920 describes a method for determining spectral calibration data of a Fabry-Perot interferometer.

Document EP0378267 describes a device for measuring the cut-off wavelength of an interference filter in a television display tube.

JP-S63-182541 relates to the measurement of characteristics, such as optical losses or optical power splitting ratio, of an optical multiplier/demultiplier.

### SUMMARY OF THE INVENTION

The Applicant has noticed that the optical device observation techniques of the known art present excessive complexity, both in computational terms and in relation to their structural implementation.

The present invention addresses the problem of providing an alternative optical device observing system to the known ones, which has not particularly computationally onerous modes of operation and is not significantly complex from a structural point of view, while at the same time ensuring due efficiency, accuracy, and reduced observing time.

According to a first aspect, the present invention is directed to an optical system as described by claim 1 and preferred embodiments thereof as defined by claims 2-14. It is also an object of the present invention to method of observing an optical system as defined by claim 15.

### BRIEF DESCRIPTION OF THE DRAWINGS

The present invention is hereinafter described in detail, by way of illustration and not limitation, with reference to the accompanying drawings, in which:

FIG. 1 shows an example of a first form of implementation of an optical system including an optical reference device and a device to be observed;

FIG. 2 shows illustratively the spectra of an optical radiation on two complementary outputs, band-clear and band-pass, of said optical devices;

FIG. 3 shows schematically an optical device with more than two output ports employable in said optical system;

FIG. 4(a) shows the intensity response as a function of wavelength of an optical device not yet tuned, and FIG. 4(b) shows the intensity response as a function of wavelength of a tuned or reference device;

FIG. 5 shows the power trend on two output ports of the optical device to be observed of FIG. 4a during the tuning process;

FIG. 6 shows schematically, as an example of a device, a coupled resonant ring filter that can be used in said optical system;

FIG. 7 shows the intensity of wavelength responses observed experimentally on two output ports, bandpass (solid line) and band-elimination (dot stretch line) of the filter in FIG. 6;

FIG. 8 shows the wavelength-dependent intensity responses obtained experimentally and related to a reference filter (dashed lines) and the controlled optical device (solid lines);

FIGS. 9-12 show the power spectral densities output to an optical detector of the optical system of FIG. 1 in different possible configurations and also show graphs describing the trend of a signal sent to a controller of said system;

FIG. 13 refers to the device in FIG. 6: FIG. 13(a) relates to a situation in which the bandpass gate is subject to random perturbations; FIG. 13(b) shows the mean square error of the wavelength response of the device with respect to a desired response and the power output from the same device for different cases of perturbation, shown in

FIG. 13(a).

### DETAILED DESCRIPTION

In this description, similar or identical elements or components will be referred to in the figures with the same identifying symbol.

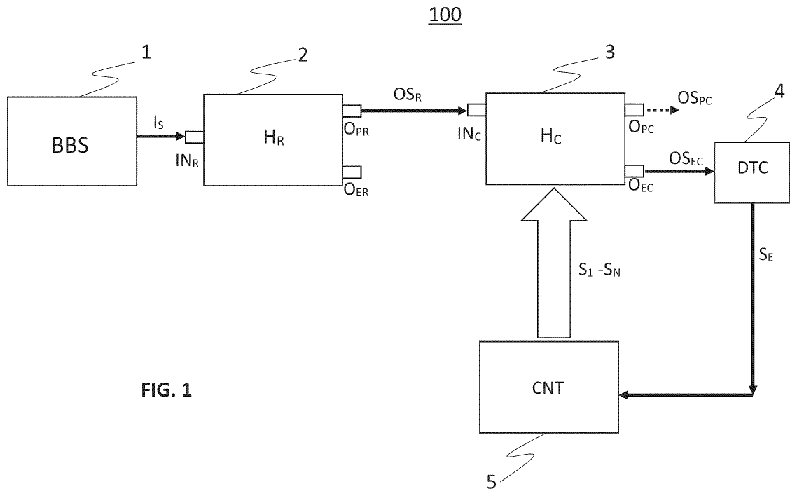

FIG. 1 schematically shows an example of a first form of implementation of an optical system 100 comprising: an optical radiation source 1 (BBS), an optical reference device 2 (H_{R}), an optical device to be observed 3 (H_{C}), and an optical detector 4 (DTC). In addition, according to the first described form of implementation, the optical system 100 includes a controller 5 (CNT) of the optical device to be observed 3.

In particular, the optical system 100 is such that it operates with electromagnetic radiation at wavelengths between, preferably, 300 nm and 5000 nm, between 1250 nm and 1750 nm.

For example, optical system 100 is a system that operates in the fields of optical telecommunications, optical interconnection, optical signal and image processing, and sensing.

Optical system 100 is suitable for observation of optical device 3. As already reported, for the purposes of the present invention, observation means at least one of the following operations performed on optical device 3: tuning, monitoring, testing, and control of the considered device.

In tuning one operates so that the optical device 3 assumes a predetermined state of operation. In particular, such tuning can be carried out at a calibration step following the production of the device itself. The term monitoring refers to the set of operations aimed at maintaining the required functional characteristics of the optical device 3 in the face of external perturbations (e.g., changes in temperature, optical, electrical, acoustic interference, etc.) and/or aging phenomena.

Monitoring involves observing the state of the optical device 3 during its operation to detect deviations from the required functional characteristics. Testing is the verification of the functional characteristics of the optical device 3 to validate and/or rank its performance against specifications.

According to the implementation form of FIG. 1, the optical device to be observed 3 is a reconfigurable device and the optical system 100 is such that it tunes and/or controls the optical device 3. For the purpose of monitoring and testing, the optical device 3 is not necessary reconfigurable.

Referring to FIG. 1, the optical device to be observed 3 (hereafter optical device 3 for the sake of brevity) is equipped with at least one first input port IN_{C} for an input optical radiation and one or two output ports.

Optical device 3 is of the selective type in wavelength and that is, it is such that it distributes to the two output ports portions of the input optical radiation present at the first input port IN_{C}. Note that the two output ports may not be physically distinct from the input port, as is the case in reflective devices in which one output port physically coincides with the input port, but the radiation propagates in the opposite direction.

According to another version, one of the two output ports may not be reachable from the outside (so it is as if it were not present), as is the case, for example, in devices that introduce wavelength-selective losses in which the internally dissipated optical power represents the optical output of the port that is not reachable from the outside.

A form of realization in which the device to be observed 3 has more than two output ports will also be described later.

Specifically, the optical device 3 depicted in FIG. 1 has a first bandpass port O_{PC} to which input radiation belonging to a given wavelength band B_{P} is sent and a first band-stop port O_{EC} to which input radiation belonging to an additional wavelength band B_{E} other than the band Br is sent.

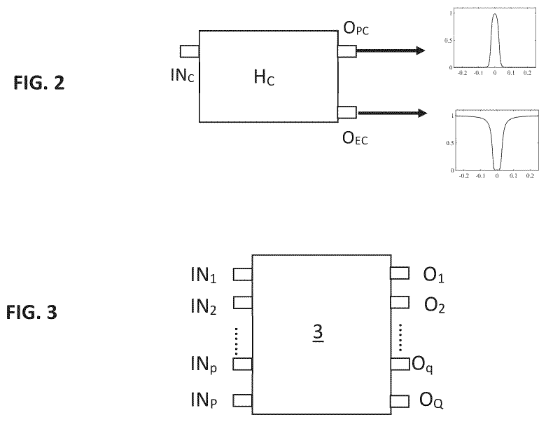

FIG. 2 shows example trends of the spectrum of optical radiation on the first band-stop port O_{EC} and the output band-pass port O_{PC}. In this example, as appears from FIG. 2, the first band-stop port O_{EC} the first band-pass port Orc appear complementary.

For example, the optical device 3 is a band-pass or band-stop filter that can be used as an interleaver, multiplexer/demultiplexer, OADM (Optical Add and Drop Multiplexer) tunable or reconfigurable (TOADM, ROADM), switch (WSS, Wavelength Selective Switch), router, dispersion compensator. Other possible optical devices with similar functionality to optical device 3 are: single or multiple Mach-Zehnder interferometer circuits, circuits based on ring resonators or combination of the two, Arrayed Waveguide Gratings (AWG), Wavelength Locker, tunable devices based on Bragg Gratings.

Note that the terms “band-stop port” and “band-pass port,” usually employed for particular one-input, two-output devices can also be adopted for the types of optical devices listed above, as recognized by the expert in the field.

Optical device 3 provides for the possibility of changing its operating point by means of external control signals. Optical device 3 can assume different wavelength responses (or, equivalently, frequency responses) that depend on the value of a plurality of N state variables=Θ=θ₁, . . . , θ_{N} that are controlled by N control signals S₁, . . . , S_{N} provided by controller 5.

Specifically, optical device 3 includes an number N_{A} of actuators (not shown) controllable by control signals S₁, . . . , S_{N}. Note that the number of actuators N_{A} can be equal to or greater than the number N of the control signals. The actuators N_{A} can be both phase and amplitude actuators. Possible physical implementations are, for example, thermo-optic, electro-optic, acousto-optic, piezo-electric, electro-absorptive, electromechanical, or all-optical actuators (whether or not based on nonlinear optical effects). Particularly, transmission from the first input port IN_{C} to the first band-pass port O_{PC} is described by the corresponding wavelength response H_{PC,i}(λ) (where subscript i refers to a generic i-th state), and transmission from the first input port IN_{C} to the first band-stop port O_{EC} is described by a corresponding wavelength response H_{EC,i}(λ).

Considering the typology of the optical device 3, the two wavelength responses H_{PC,i}(λ) and H_{EC,i}(λ) are complementary, namely, ideally:

$${\vert {H}_{PC , i} ( λ ) \vert}^{2} = 1 - {\vert {H}_{EC , i} ( λ ) \vert}^{2} \qquad ( 1 )$$

The selectivity of the optical device 3 implies that in at least one spectral range B_{P}=|λ₁-λ₂|² (where the wavelengths λ₁, λ₂ delimit the operating band of optical device 3), the transmission | H_{PC,i}(λ)|²>>| H_{EC,i}(λ)|². The symbol>> is intended to mean that H_{PC,i}(λ) e H_{EC,i}(λ) differ in square modulus (intensity response) by at least 10 dB or equivalently:

$${\vert {H}_{PC , i} ( λ ) \vert}^{2} / {\vert {H}_{EC , i} ( λ ) \vert}^{2} > 10 \qquad ( 2 )$$

in the band B_{P}.

Note that the more this ratio decreases, the better are the performance of the optical system 100 described here.

The tuning performed by the 100 optical system is such that either the wavelength response H_{PC,i}(λ) or the response H_{EC,i}(λ) equals a target response (i.e., a desired response) Ĥ_{PC}(λ) or Ĥ_{EC}(λ), respectively.

Optical radiation source 1 is a broadband source having, in particular, a wavelength band Bs that includes (equal to or greater than) the wavelength band B_{P} in which the optical device 3 operates.

As an example, the source of optical radiation 1 may be the ASE (Amplified Spontaneous Emission) noise of an Erbium Amplifier (EDFA) or that emitted by a super-luminescent diode.

Reference optical device 2 (hereafter, for brevity, reference device) is an optical device that exhibits spectral behavior corresponding to that desired for optical device 3. More specifically, reference optical device 2 exhibits a wavelength response close to or equal to the target response for the optical device 3, namely, according to the example:

$${H}_{PR} ( λ ) = {\hat{H}}_{PC} ( λ ) and {H}_{FR} ( λ ) = {\hat{H}}_{EC} ( λ )$$

where subscripts R and C refer to the reference device 2 and the device to be observed 3, and subscripts P and E refer to the band-pass and band-stop outputs, respectively.

The reference device 2 may be implemented by a device of the same type (i.e., same structure and same technology) as optical device 3, or it may be a device different from optical device 3. In any case, the spectral density at the band-pass or band-stop output port of reference device 2 represent the reference for tuning, monitoring, testing, and controlling of optical device 3. Reference device 2 then acts as a spectral shaper of the radiation emitted by source 1.

With reference to the example described, the reference device 2 includes a second input port IN_{R} and at least a second bandpass port O_{PR}. The device may also include a second band-stop port O_{ER}. Similar to the device to be observed 3, for the reference device 2 one of the output ports may not be physically distinct from the input port or may not be reachable from the outside.

Particularly, the transmission from the second input port IN_{R} to the second band-pass port O_{PR} is described by its wavelength response H_{PR}(λ). In contrast, the transmission from the input port IN_{R} to the second band-stop port O_{ER} is described by its wavelength response H_{ER}(λ). Note that, even for reference device 2, the wavelength responses H_{PR}(λ) and H_{ER}(λ) are complementary.

According to the example of FIG. 1, one output of the radiation source 1 is coupled to the second input port IN_{R} of the reference device 2. In addition, the second bandpass port O_{PR} of the reference device 2 is coupled to the first input port IN_{C} of the optical device 3. The first band-stop port O_{EC} of optical device 3 is coupled to an input port of the optical detector 4.

Optical detector 4 is such that it converts the optical radiation coming out of the first band-stop port O_{EC} into an electrical signal S_{E} representative of the power of that exiting optical radiation. The optical detector 4 is, for example, a photodiode.

Controller 5 is configured to the control optical device 3 by means of control signals S₁-S_{N} so that it assumes wavelength responses as similar as possible to those of the reference device 2, relative to the same outputs.

Controller 5 can be realized, for example, by a microcontroller, a CPU (Central Processing Unit), an FPGA (Field Programmable Gate Array) or a DSP (Digital Signal Processor), programmed according to the control methodology described below.

The following describes an example of the operation of the optical system 100, as depicted in FIG. 1.

Radiation source 1 emits an optical signal Iₛ(λ) having a power spectral density (PSD) equal to S_{S} (λ):

$${S}_{S} ( λ ) = {\vert {I}_{S} ( λ ) \vert}^{2} \qquad ( 3 )$$

This optical signal Iₛ(λ) is supplied to the second input port IN_{R} of the reference device 2, which returns a first output signal OS_{R}(λ) to the second band-pass port O_{PR}, given by the following relationship

$${OS}_{R} ( λ ) = {H}_{PR} ( λ ) {I}_{S} ( λ ) \qquad ( 4 )$$

The first output signal OS_{R}(λ) is then supplied to the first input port IN_{C} of the optical device 3 which returns a second output signal OS_{PCi}(λ) present at the first band-pass port O_{PC} of optical device 3 and expressed by the following relation:

$${OS}_{PC , i} ( λ ) = {H}_{PC , i} ( λ ) {OS}_{R} ( λ ) = {H}_{PC , i} ( λ ) {H}_{PR} ( λ ) {I}_{S} ( λ ) \qquad ( 5 )$$

where subscript i denotes the i-th state of device 3. It follows that a first power spectral density S_{PC,i}(λ) of the second output signal OS_{PC,i}(λ) from relation (5) is expressed by the following relation:

$${S}_{PC , i} ( λ ) = {\vert {OS}_{PC , i} ( λ ) \vert}^{2} = {\vert {H}_{PC , i} ( λ ) \vert}^{2} {\vert {H}_{PR} ( λ ) \vert}^{2} {\vert {I}_{S} ( λ ) \vert}^{2} \qquad ( 6 )$$

For the reference device 2, the wavelength response H_{PR}(λ) is equal to the target response: H_{PR} (λ)=Ĥ_{PC}(λ) defined above.

Also, note that when the optical device to be observed 3 achieves the desired behavior (state M), its wavelength response H_{PC,M}(λ) is also equal to Ĥ_{PC}(λ), and the relation (6) takes the following form:

$${S}_{PC , M} ( λ ) = {\vert {OS}_{PC , M} ( λ ) \vert}^{2} = {\vert {\hat{H}}_{PC} ( λ ) \vert}^{4} {\vert {I}_{S} ( λ ) \vert}^{2} = {\vert {\hat{H}}_{PC} ( λ ) \vert}^{4} {S}_{S} ( λ ) \qquad ( 7 )$$

where S_{S}(λ) is the power spectral density of the input signal I_{S}(λ).

Relationship (7) shows that when the behavior of the optical device to be observed 3 equals that of the reference device 2, the first power spectral density S_{PC,M}(λ) takes on a maximum value.

We refer to the second band-stop port O_{EC} of the optical device 3 that provides a third output signal OS_{EC}(λ), produced in response to the first output signal OS_{R}(λ). Such a third OS_{EC}(λ) output signal can be expressed as:

$${OS}_{EC , i} ( λ ) = {H}_{EC , i} ( λ ) {OS}_{R} ( λ ) = {H}_{EC , i} ( λ ) {H}_{PR} ( λ ) {I}_{S} ( λ ) \qquad ( 8 )$$

Considering relation (8), a second power spectral density S_{EC,i}(λ) of the third output signal OS_{EC,i}(λ) in the generic i-th state is expressed by the following relation:

$${S}_{EC , i} ( λ ) = {\vert {OS}_{EC , i} ( λ ) \vert}^{2} = {\vert {H}_{EC , i} ( λ ) \vert}^{2} {\vert {H}_{PR} ( λ ) \vert}^{2} {\vert {I}_{S} ( λ ) \vert}^{2} \qquad ( 9 )$$

Due to the complementarity of the output ports of reference device 2, we have that: | H_{EC,i}(λ)|²=1−| H_{PC,i}(λ)|² (i.e., equation (1)). Furthermore, the wavelength response H_{PR}(λ) of the reference device 2 is equal to the target response H_{PR} (λ)=Ĥ_{PC}(λ).

As mentioned above, when the optical device 3 achieves the desired behavior (state M), its wavelength response H_{EC,M}(λ) is also equal to Ĥ_{EC}(λ).

Therefore, relation (9) can be rewritten as below:

$${S}_{EC , M} ( λ ) = {\vert {OS}_{EC , M} ( λ ) \vert}^{2} = {\vert {\hat{H}}_{PC} ( λ ) \vert}^{2} ( 1 - {\vert {\hat{H}}_{PC} ( λ ) \vert}^{2} ) {S}_{S} ( λ ) . \qquad ( 10 )$$

Relationship (10) shows how, when the behavior of the optical device 3 equals that of reference device 2, the second power spectral density S_{EC,M}(λ) takes on a minimum value.

The third output signal OS_{EC,i}(λ) (of relation 8) is received at the input port of optical detector 4 which returns an electrical signal S_{E} (of voltage or current) proportional to the optical power P_{EC,i} of that third output signal OS_{EC,i}(λ).

The optical power P_{EC,i} is equivalent to the integral over one band (B_{R}) of optical detector 4 of the second power spectral density S_{EC,i}(λ) expressed by the relation (9):

$${P}_{EC , i} = {\int }_{BR} {S}_{EC , i} ( λ ) d λ . \qquad ( 11 )$$

The electrical signal S_{E} is supplied to the controller 5, which operates according to a control law based on minimization of optical power P_{EC,i} so as to achieve the condition of relation (10).

Note that in this case, an output port (O_{PR}) of reference device 2 complementary to the output port (O_{PC}) of optical device 3 connected to the optical detector 4 was used for control purposes.

In more detail, the controller 5 acts on the actuators of optical device 3 in such a way as to vary its state variables θ₁, . . . , θ_{N} minimizing the optical power P_{EC,i} represented by the electrical signal S_{E} and thus bringing the wavelength response H_{EC,i}(λ) take on the trend of the response Ĥ_{EC}(λ).

The controller 5 changes the operating point of the actuators and operates the search for an optimal set of state variables Θ-θ₁, . . . , θ_{N} according to a minimization technique such as, for example: the least square mean error (LSME) technique, the gradient technique, a genetic algorithm.

In the case of tuning, the process begins by bringing all the N_{A} actuators to a predefined initial operating point (e.g., all off or at defined values: i=1)) and present in the controller memory 5. At this point the optical device to be observed 3 has wavelength response H_{EC,1}(λ). The operating point of the actuators is then changed by an amount much smaller than their dynamics, and the wavelength response at the O_{EC} port becomes H_{EC,2}(λ).

If an error function (represented by power P_{EC}) is reduced, then the direction in which the operating point is moving is correct otherwise we have moved away from the target. Controller 5 generates a new set of control signals S₁-S_{N} to be sent to the actuators, and a further iteration is performed. At each iteration, the wavelength response is changed until H_{EC,i}(λ) takes on the trend Ĥ_{EC}(λ), which minimizes the residual error. Under these conditions, the value of ‘i’ reached represents the desired state M.

In an alternative version to that in FIG. 1, optical detector 4 is connected to the first band-pass port O_{PC} of the device 3 and then receives the second output signal OS_{PC}(λ) present at the first band-pass port O_{PC}, in response to the signal coming out of the first band-pass port O_{PR} of the reference device 2. In this version, the non-complementary ports (both bandpass ports) of the optical device 3 (O_{PC}) and the reference device 2 (O_{PR}) were used.

In such a case, controller 5 acts to maximize the optical power associated with the first power spectral density S_{PC,i}(λ) expressed by relation (6) and thus bring itself into the situation indicated by relation (7).

The control or tuning process carried out by controller 5 in the case of output power maximization is similar to that described above for the case of output power minimization (relations (9) and (10)).

The above description for optical devices having one input port and two output ports can also be extended to devices with more than one input port and with more than two output ports. FIG. 3 schematically shows an optical device to be observed 3 having P input ports (IN₁-IN_{P}) and Q output ports (O₁-O_{Q}). A similar schematization applies to the reference device 2.

In this case each output port is connected to a related optical detector 4, which in turn is connected to the controller 5. In an alternative realization some of the output ports can be combined and connected to the same detector, as known to the expert in the field.

The wavelength response relative to the input and output ports employed for reference device 2 is H_{R}(λ). The wavelength response assumed by the reference device 2 and corresponding to the target wavelength response for optical device 3 is: H_{R}(λ)=Ĥ_{c,pq}(λ).

The wavelength response from the input port p to the output port q for optical device 3 is: H_{C,pq}(λ). If H_{c,pq}(λ) represents the wavelength response to the bandpass port (and consequently H_{C,ps}(λ), for each s≠q, are wavelength responses to the band-stop ports), regarding selectivity, condition (2) can esse rewritten as

$${\vert {H}_{C , pq} ( λ ) \vert}^{2} / {\vert {H}_{C , p s} ( λ ) \vert}^{2} > 10 ( con s \neq q ) \qquad ( 12 )$$

In a first case, consider that the reference device 2 is of the same type as the optical device 3. Consider the power spectral density at an output port of the optical device 3 of a similar type (band-pass or band-stop) to the output port employed for the reference device 2. In that case, the power spectral density from the input port p of the reference device 2 to the output port q of the device to be observed 3 (analogous to expression (6)) is dependent on the product:

$${\vert {H}_{C , pq} ( λ ) \vert}^{2} {\vert {H}_{R , pq} ( λ ) \vert}^{2} \qquad ( 13 )$$

This product takes the maximum value when H_{R,pq}(λ)=Ĥ_{c,pq}(λ) and that is:

$${\vert {H}_{R , pq} ( λ ) \vert}^{2} {\vert {\hat{H}}_{C , pq} ( λ ) \vert}^{2 =} {\vert {\hat{H}}_{C , pq} ( λ ) \vert}^{4} \qquad ( 14 )$$

Therefore, relation (13) shows the quantity to be maximized by controller 5 to approach the condition of relation (14).

According to another situation, consider that the reference device 2 is of a complementary type to the optical device to be observed 3. By “complementary” we mean the function Σ_{s≠q}|Ĥ_{C,ps}(λ)|² with s≠q, given by the sum of the frequency responses on all other output ports. Considering lossless devices:

$${\sum }_{s \neq q} {\vert {\hat{H}}_{C , p s} ( λ ) \vert}^{2} + {\vert {\hat{H}}_{C , pq} ( λ ) \vert}^{2} = 1 \qquad ( 15 )$$

while in the presence of leakage

$${\sum }_{s \neq q} {\vert {\hat{H}}_{C , p s} ( λ ) \vert}^{2} + {\vert {\hat{H}}_{C , pq} ( λ ) \vert}^{2} \approx 1. \qquad ( 16 )$$

Consider also the power spectral density at an output port of optical device 3 of a complementary type to the output port employed for reference device 2. In that case, the power spectral density at the output port q of optical device 3 (analogous to expression (10)) is product dependent:

$${\vert {H}_{R , pq} ( λ ) \vert}^{2} ( 1 - {\vert {H}_{C , pq} ( λ ) \vert}^{2} ) \qquad ( 17 )$$

This product takes the minimum value when H_{R,pq}(λ)=Ĥ_{C,pq}(λ) and that is:

$${\vert {H}_{R , pq} ( λ ) \vert}^{2} ( 1 - {\vert {\hat{H}}_{C , pq} ( λ ) \vert}^{2} ) \qquad ( 18 )$$

is minimal.

Thus, expression (17) shows the quantity to be minimized by controller 5 in a similar way as described above.

Thus, under the assumption of relation (12) regarding selectivity, using the p-th port as input, the controller 5 operates in the following alternative ways A) and B):
A) It maximizes the power output from the q-th port.
B) It minimizes the summation of the power output from ports other than the q-th port (Σ_{s≠q} P_{out,s}).

In the implementation form of FIG. 1, source 1 is connected to reference device 2, which is cascaded with optical device to be observed 3. According to an alternative implementation form, the positions of the two optical devices can be reversed and thus provide that source 1 is connected to the optical device to be observed 3, which is cascaded with reference device 2 that has an output port connected to optical detector 4.

In that case the same power spectral density relations (6) and (9) remain valid, as do the control modes operated by controller 5, described above.

In addition, regarding the possible modes of connection between the ports of optical device 3 and reference device 2, solutions other than those described above can also be provided.

For example, it is possible that optical device to be observed 3 and reference device 2 are connected to each other so that the optical output signal provided to optical detector 4 depends on the cascade of wavelength responses relative to the respective band-pass ports: H_{PR}(λ) and H_{PC}(λ). In this case, control 5 operates to maximize the optical power of the signal received at the detector itself.

In addition, it is possible that optical device 3 and reference device 2 are connected to each other so that the optical output signal provided to optical detector 4 depends on the cascade of wavelength responses relative to the respective band-pass ports: H_{ER}(λ) e H_{EC}(λ). In this case, the controller 5 operates to minimize the optical power of the signal received at optical detector 4.

In the case of devices with more than one input port and more than two output ports, controller 5 operates as indicated in (A) and (B) above.

The following table summarizes the error function optimization strategy performed by controller 5 described above depending on the type of connection between the ports.

| Output of the reference device 2 | | |
|---|---|---|
| Output of the optical device 3 | Band-Stop Port | Band-pass Port |
| Band-stop Port | Maximization | Minimization |
| Band-pass Port | Minimization | Maximization |

Note that the optical system 100 (for example, in its various forms of implementation described above) can be used not only for tuning and control purposes but also for testing or monitoring purposes. Testing or monitoring can also be done for an optical device 3 type that cannot be reconfigured or tuned.

It should also be noted that reference device 2 may have only one output port (of the band-stop or band-pass type).

In testing or monitoring cases, the controller 5 acting on the actuators of the optical device 3 is replaced by a processing device that still operates by analyzing the optical power of the signal received at the optical detector 4 and from this obtains information about the deviation of the behavior of the optical device 3 from the behavior of the reference device 2.

The following describes results obtained experimentally or obtained by numerical simulations related to the operation of the optical system 100.

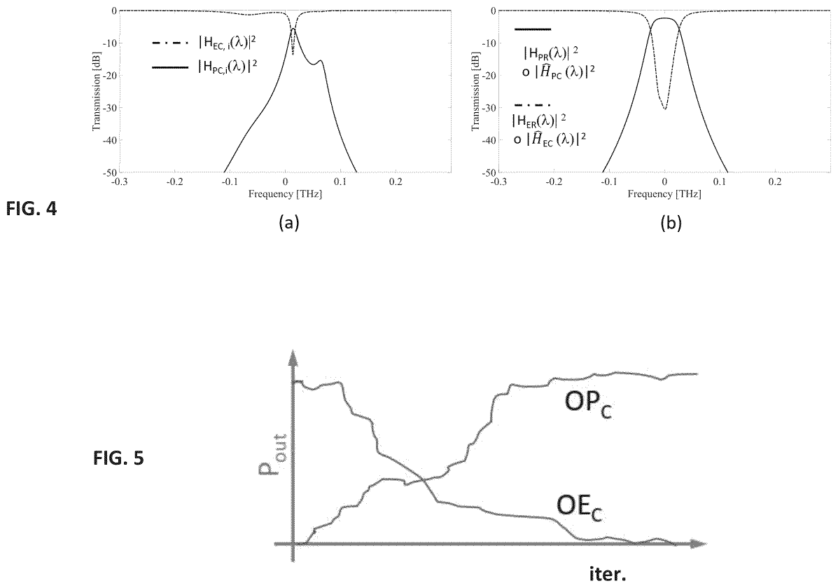

FIG. 4 refers to an example of tuning a generic filter with one input and two outputs, one band-clear and one band-pass, by the approach described with reference to FIG. 1. The spectral response of the two outputs is both H_{PC}(λ) and H_{EC}(λ).

FIG. 4(a) shows the intensity of the H_{EC,i}(λ) and H_{PC,i}(λ) spectral response of a generic optical device 3 that has not yet been tuned, and FIG. 4(b) shows the intensity response of the reference device 2 to which it must tend after tuning Ĥ_{EC} e Ĥ_{PC}.

Assume that the output H_{PR} (H_{ER}) of the device 2 is used. When the device to be observed 3 is not tuned, the output power measured by detector 4 is worth P_{PC,1} (P_{EC,1}) and corresponds to the first measured value. By successively changing the set Θ iteratively as described above, the output power increases (decreases) to a maximum (minimum) equal to \hat{P}_{PC} (\hat{P}_{EC}) to which corresponds the best-tuned filter to be observed 3, with spectral responses Ĥ_{PC} e Ĥ_{EC} at its output ports. The performance of P_{PC,i}(P_{EC,i}) at the ports O_{PC} and O_{EC} in the two cases is depicted in FIG. 5.

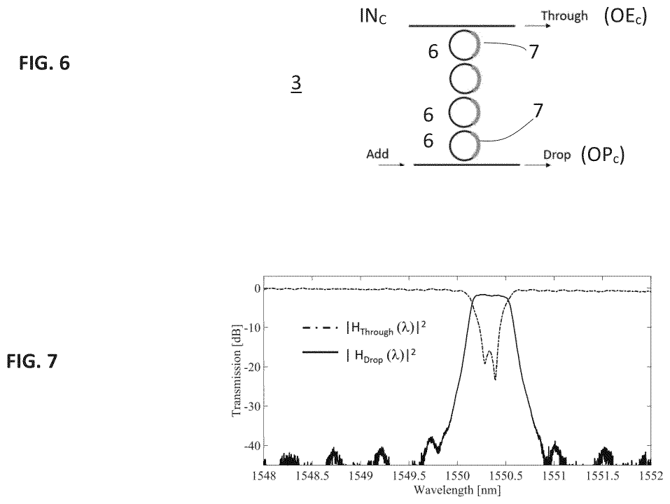

The validity of the present invention is also supported by experimental results. For example, the described technique has been tested for a fourth-order filter 3 having coupled resonant rings 6 made in silicon photonics technology, shown in FIG. 6. Such a filter 3 has two input ports (In_{C} and Add) and two output ports. Upon entering with a signal into the port In_{C}, one of the two outputs is band-stop (Through) and the other is band-passing (Drop).

The device in FIG. 6 is equipped with four thermo-optical actuators 7 on each individual resonant structure 6. The filter 3 designed to have a minus 3 dB bandwidth above 40 GHz (measured at the Drop gate) and an average rejection of 17 dB (over 20 GHz around the center frequency).

The filter of FIG. 6 used in the experiment is made with integrated silicon waveguides. However, other propagating materials such as semiconductors (InP, InGaAs, SiC), LiNbO, dielectrics (SiO2:Ge, SiON, SiOC, SiN, SiOF, ITO, BaTiO) and polymers (acrylates, polyimides, polycarbonates, alkenes) can be used. Other physical implementations besides integrated optics are also possible, such as free-space optics or micro-optics.

The squared modulus of the wavelength responses observed at both output ports (| H_{drop}|² e| H_{through}|²) is shown in FIG. 7 when the filter 3 is tuned to best effect. This response is obtained by resorting to the scheme shown in FIG. 1 with a reference device 2, placed downstream of a broadband ASE source, nominally equal to test filter 3, with a bandwidth of about 40 GHz, just as per the filter specification in FIG. 6.

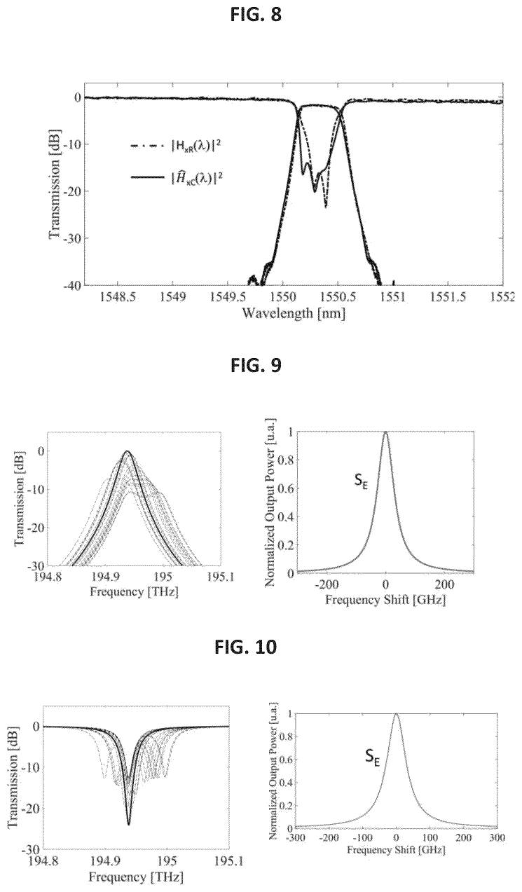

FIG. 8 refers to an experiment performed with an optical system similar to that in FIG. 1, employing a reference device 2 nominally identical to the optical device of Test 3 to be tuned or tested.

In this case, the output O_{PR} (i.e., the Drop port) was connected to the input IN_{C} of the optical device under Test 3. Applying the described tuning technique results in the device under Test 3 assuming a wavelength response (observed in both outputs O_{PC} and O_{EC}) very similar to that of Reference 2. In other words, the device to be tuned 3 turns out to be a faithful replica of reference filter 2.

Therefore, using a nominally identical version as reference filter 2, the technique described above can be employed to calibrate the device to be tuned 3 and find a working point that puts it in the same condition as the reference device. FIG. 8 shows the experimental result of this first application: the dashed curves are for reference filter 2, while the solid curves are for tuned optical device 3.

The, Ĥ_{drop}(λ) is the wavelength response observed at the Drop port of reference filter 2 and Ĥ_{through}(λ) is the wavelength response observed at the Through port of Test filter 3 (at the end of the tuning procedure), it turns out that the power spectral density output from the series of the two devices is (assuming that a broadband, flat-spectrum source is used):

$${S}_{out , thr} ( λ ) = {\vert {\hat{H}}_{through} ( λ ) {H}_{drop} ( λ ) \vert}^{2} \qquad ( 19 )$$

and then detector 4 (downstream of the system, placed at the Through port of optical device 3) reads a power Pₒᵤₜ equal to

$${P}_{out , thr} = {\int }_{BR} {S}_{out , thr} ( λ ) d λ \qquad ( 20 )$$

where B_{R} is the band of optical detector 4.

As already noted, in the case where the filter to be tuned 3 is the perfect replica of reference 2 such a power value is the minimum possible. Otherwise the power P_{out,thr} is an indication of how different the two devices are from a wavelength response point of view.

Shown in FIGS. 9-11, as an example, are the output power spectral densities when the spectral response of the reference device 2 is not centered at the same frequency as that of the device to be observed 3 (the continuous curve represents the optimal case H_{C}(λ)=H_{R}(λ), i.e., the two frequency responses are centered at exactly the same frequency). Also depicted are graphs describing the trend of the detected power (Pₒᵤₜ), and thus of the electrical signal S_{E} as a function of the frequency mismatch between the spectral response of the reference and that of the device to be tuned.

FIG. 9 considered the case where the relevant band-pass port is used for both the optical device under Test 3 and the reference device 2.

FIG. 10 considered the case where the band-stop port is used for both the optical device under Test 3 and the reference device 2.

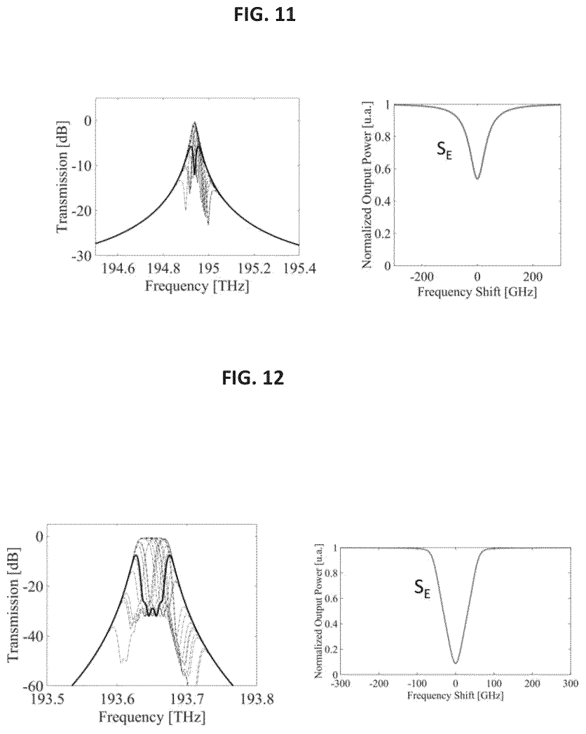

FIG. 11 considered the case where the band-stop port is used for the optical device under Test 3 and the band-pass port is used for the reference device 2.

FIGS. 9-11 were generated, simulating the frequency response of a filter consisting of a single ring resonator.

FIG. 12 considered the case where the band-pass port was used for the optical device to be observed 3 and the band-stop port for the reference device 2, considering a filter under Test 3 with coupled fourth-order resonators, such as that shown in FIG. 6.

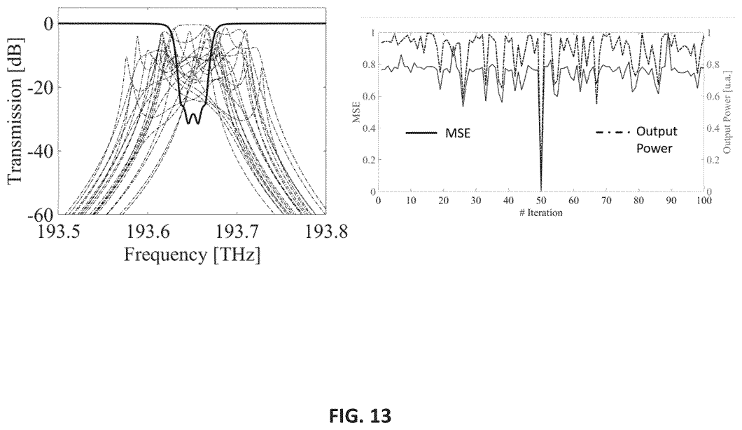

With reference to the same device in FIG. 6, also shown in FIG. 13(a) is the situation in which the band-pass port of the filter to be observed 3 is subject to random perturbations. The solid line in this case indicates the band-stop port of the reference filter 2. In FIG. 13(b), we also show the power of the optical signal P_{out,thr} collected at the output and the mean square error (MSE) calculated as

$$MSE = \frac{1}{Δ λ} \int {\vert {H}_{drop} ( λ ) - {\hat{H}}_{drop} ( λ ) \vert}^{2} d λ \qquad ( 21 )$$

between the frequency response of the reference device 2 (H_{drop}(λ)) and that of the filter to be tuned 3 in the target state (Ĥ_{drop}(λ)), both considered at the bandpass port. From the latter figure, a strong correlation between output power P_{out,thr} and the MSE quantity can be observed. Thus minimizing the output power P_{out,thr} is equivalent to minimizing the mean square error MSE between the frequency response of the reference filter 2 and that of the filter to be tuned 3 in the target state.

### Advantages

As appears from the preceding description, the optical system 100 and the method described allow tuning, monitoring, testing, or control operations of an optical device to be carried out in an extremely simpler and quicker way than is done according to the known art.

In fact, the method of the present solution makes it possible to avoid measuring the entire spectrum of the observed optical device.

The described methodology also has time advantages in that the measurement of optical power and subsequent processing is much faster than that based on spectrum measurement.

### LEGEND

optical system 100
optical radiation source 1
reference device 2
optical device to be observed 3
optical detector 4
controller 5
resonant rings 6
thermo-optical actuators 7
control signals S₁-S_{N}
first input port IN_{C}
first band-pass port O_{PC}
first band-stop port O_{EC}
second input port IN_{R}
second band-pass port O_{PR}
second band-stop port O_{ER}
first output signal O_{SR}
second output signal O_{SPc}
third output signal O_{SEC}
electrical signal S_{E}
input ports (IN₁-IN_{P})
output ports (O₁-O_{Q})

1. An optical system comprising:
an optical radiation source to provide an optical input signal;
an optical detector;
a processing module;
an optical device operable to have a first input and including at least one of a first band-pass output and a first band-stop output, wherein the first band-pass output is associated with a first band-pass wavelength response, and wherein the first band-stop output is associated with a first band-stop wavelength response complementary to the first band-pass response; and
an optical reference device operable to have a second input and including at least one of a second band-pass output and a second band-stop output, wherein the second band-pass output is associated with a second band-pass wavelength response, and wherein the second band-stop output is associated with a second band-stop wavelength response complementary to the second band-pass response;
wherein: the optical device and the optical reference device are coupled together to form a cascade;
wherein at least one of the optical device and the optical reference device is connected to the optical radiation source;
wherein at least one of the optical device and the optical reference device of the cascade provides an optical output signal;
wherein the optical detector converts the optical output signal into an electrical measurement signal that is representative of an optical power of the optical output signal; and
wherein the processing module determines deviations between at least one of the first band-pass wavelength responses and the second band-pass wavelength response, and the first band-stop wavelength responses and the second band-stop wavelength response, based on the electrical measurement signal.

2. The optical system according to claim 1, further configured in at least one of:
a first configuration comprising the optical reference device connected to the optical radiation source, and the optical device connected to the optical detector; and
a second configuration comprising the optical device connected to the optical radiation source, and the optical reference device connected to the optical detector.

3. The optical system according to claim 1,
wherein the optical output signal provided by the cascade includes an optical power that is dependent on at least one of, a product of the band-stop responses, product of the band-pass responses, product of the first band-pass response with the second band-stop response, and product of the first band-stop response with the second band-pass response.

4. The optical system according to claim 1, wherein the processing module is configured to evaluate the deviations for an operation of the optical device including at least one of tuning the optical device, controlling the optical device, testing the optical device, and monitoring the optical device.

5. The optical system according to claim 1, wherein the optical device comprises a plurality of actuators configured to change state variables of the optical device; wherein the processing module is configured to generate and provide control signals to the actuators based on the deviations evaluated by the processing module to reduce a deviations amount.

6. The optical system according to claim 5, wherein the processing module is configured to generate the control signals based on the electrical measurement signal to at least one of maximize the optical power of the output optical signal and minimize the optical power of the output optical signal.

7. The optical system according to claim 6, wherein the processing module generates the control signals to maximize the optical power of the optical output signal when the optical power depends on a total wavelength response that comprises at least one of a product of the band-stop responses and product of the band-pass responses.

8. The optical system according to claim 6, wherein the processing module is configured to generate the control signals to minimize the optical power of the optical output signal when the optical power depends on the product of the first band-stop response with the second band-pass response.

9. The optical system according to claim 8, wherein the optical device comprises at least one output port connected to a respective optical detector; and wherein the processing module is operable to minimize a summation of the optical power output to the at least one output port and to at least one of the second band-pass output and the second band-stop output.

10. The optical system according to claim 6, wherein the processing module is operable to perform a technique including at least one of a least square mean error LSME technique, gradient technique, and genetic algorithm.

11. The optical system according to claim 1, wherein the optical reference device includes at least one of the second band-stop wavelength response being equal to a target wavelength response of the optical device, and the second band-pass wavelength response being equal to a target wavelength response of the optical device.

12. The optical system according to claim 11, wherein the optical reference device is operable to generate an input optical signal based on a device type of the optical reference device compared to a device type of the optical device.

13. The optical system according to claim 1, wherein the optical device comprises at least one of a Band-pass filter, band-stop filter, interleaver, multiplexer/demultipler, fixed OADM, reconfigurable OADM, tunable OADM, WSS switch, router, dispersion compensator, Mach-Zehnder single interferometer circuit, Mach-Zehnder multiple interferometer circuit, Ring Resonator-based circuits, Ring Resonator-based circuit in combination with Mach-Zehnder interferometer circuit, Arrayed Waveguide Gratings, Wavelength Locker, and Bragg grating-based device.

14. The optical system according to claim 1, wherein the optical device operates in a wavelength band defined as a second wavelength band, wherein the optical radiation source has a first wavelength band equal to or greater than the second wavelength band of the optical device; and wherein the optical device is wavelength selective.

15. A method of observing an optical device comprising:
generating an optical input signal;
providing an optical device having a first input and at least one of a first band-pass output associated with a first band-pass wavelength response, and a first band-stop output associated with a first band-stop wavelength response complementary to the first band-pass response;
providing an optical reference device having a second input and at least one of a second band-pass output associated with a second band-pass wavelength response, and a second band-stop output associated with a second band-stop wavelength response complementary to the second band-pass response;
wherein the optical devices and the optical reference device are coupled together to form a cascade;
wherein at least one of the optical devices and the optical reference device is connected to the optical radiation source; and
wherein at least one of the optical device and the optical reference device is operable to provide an optical output signal;
converting the optical output signal into an electrical measurement signal representative of an optical power of the optical output signal; and
evaluating deviations between at least one of said the first band pass wavelength responses and the second band-pass wavelength response, and the first band stop wavelength response and the second band-stop wavelength response, based on the electrical measurement signal dependent on the optical power.
